(19) United States
(12) Patent Application Publication
(10) Pub. No.: US 2013/0327771 A1
(43) Pub. Date: Dec. 12, 2013

(54) Dry Food Packaging Display and Storage Container

(71) Applicant: John Howell Vann, Panama City, FL (US)

(72) Inventor: John Howell Vann, Panama City, FL (US)

(21) Appl. No.: 13/912,260

(22) Filed: Jun. 7, 2013

Related U.S. Application Data
(60) Provisional application No. 61/656,624, filed on Jun. 7, 2012.

(51) Int. Cl. A47J 47/06

(52) U.S. Cl. CPC A47J 47/06
USPC 220/212.5; 220/62.18; 220/345.6

(57) ABSTRACT

A container for dry food storage and product packaging display. The container generally comprises a body, a lid and a base. The body comprises a food storage member, which is further comprised of an inner wall, an outer wall, a member base and a seam. The inner wall and member base form a storage cavity for the dry food, while the inner wall, seal and outer wall form a storage compartment for the product packaging. The base is removably attached to the body and encloses the storage compartment when attached to the body. The lid is removably attached to the body and encloses the storage cavity when attached to the body. The outer wall is comprised of a clear material, such that the product packaging can be viewed through the outer wall so that user can easily identify the contents of the storage container. Once the product packaging has been inserted into the storage compartment, the double-walled body is placed onto the base and is protected and held in position by means of the base seal.

### CROSS-REFERENCES TO RELATED APPLICATIONS

Pursuant to the provisions of 37 C.F.R. §1.53(c), this non-provisional application claims the benefit of an earlier-filed provisional patent application. The earlier application was assigned Ser. No. 61/656,624. It lists the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

The present invention relates to the field of counter-top storage and display devices for pre-packaged dry food products. More specifically, the present invention comprises a double-walled food storage container capable of storing dry food products in a hermetically sealed container and housing the original product packaging which can be displayed visually through the outer translucent walls, identifying the product within.

2. Description of the Related Art

Containers and canisters for the storage of dry food products, such as coffee, flour, and sugar, are commonly found in pantries or on the counter-tops of both residential and commercial kitchens alike.

Unfortunately, when these containers and canisters are closed, it is often difficult to discern what foods are being stored within. Some of these storage devices come with pre-marked, permanent labels, such as “COFFEE”, “FLOUR” or “SUGAR,” which are imprinted onto or permanently attached to the container itself. However, if a user wishes to store an alternate food product, other than designated by the container label in such a pre-marked container, then the labeling becomes inaccurate. Other such storage devices have an area upon which a user can write or adhere custom labels; but, as these labels are not permanent, they can easily become discernible and often have to be replaced. When this happens, it can become tedious and lead to mislabeling; such as when both decaffeinated and caffeinated coffee are stored in otherwise identical containers and their labels are missing or become illegible.

Therefore, what is needed is a dry food products storage container that allows the user to easily and decoratively display the original product packaging which will result in accurately identifying the contents within the container. The present invention achieves these objectives, as well as others, which are explained in the following description.

### BRIEF SUMMARY OF THE INVENTION

The present invention comprises a dry food packaging display and storage container. The display and storage container generally comprises a double-walled body and a lid and base. The double-walled body generally comprises a food storage compartment, which is further comprised of inner walls and inner base. Dry food products can be stored in this storage compartment and kept fresh by means of the hermetic seal created between the storage cavity and the container seal located on the posterior side of the lid when in the closed position. The lid can be opened by means of the handle on the container top.

The top of the inner wall is then connected by way of a top wall or seam to the top of the translucent outer wall. The space between the inner wall, outer wall and top wall or seam comprises the storage compartment, which is open on the bottom. After the dry food product is emptied into the food storage compartment, the lid is then placed onto the top of the container. The product packaging is then inserted into the storage compartment. Since the outer wall is made of a clear material, such as plastic or glass, the product packaging can be viewed through the outer wall so that a user can easily identify the contents of the storage container. Once the product packaging has been inserted, the double-walled body is placed onto the base and is protected and held in position by means of the base seal.

### BRIEF DESCRIPTION OF THE SEVERAL VIEWS OF THE DRAWINGS

FIG. 1 is a perspective view, showing the present invention.

FIG. 2 is a cross-section view, showing the preferred embodiment of the double-walled body of the present invention.

FIG. 3 is a perspective view, showing the hermetic lid being placed onto the double-walled body of the present invention.

FIG. 4 is a perspective view, showing the double-walled body being placed onto the base of the present invention.

FIG. 5 is a perspective view, showing an example of prior art pre-packaged dry food.

FIG. 6 is a perspective view, showing dry food product being poured into the present invention.

FIG. 7 is a perspective view, showing the prior art product packaging being installed into the storage compartment of the present invention.

FIG. 8 is a perspective view, showing the double-walled body being placed onto the base of the present invention with the prior art dry food product packaging installed.

FIG. 9 is a perspective view, showing alternate embodiments of the present invention housing different sizes and types of prior art dry food product packaging when fully assembled.

FIG. 10 is a perspective view, showing an alternate embodiment of the present invention.

FIG. 11 is a cross section view, showing an alternate embodiment of the base of the present invention.

REFERENCE NUMERALS IN THE DRAWINGS

| | | | |
|---|---|---|---|
| 10 | container | 12 | body |
| 14 | lid | 16 | base |
| 18 | scoop holder | 20 | scoop |
| 22 | outer wall | 24 | storage member |
| 26 | inner wall | 28 | storage member base |
| 30 | storage cavity | 32 | seam |
| 34 | storage compartment | 36 | handle |
| 38 | fully assembled containers | 40 | container seal |
| 42 | stand | 44 | base seal |
| 46 | latch | 48 | product packaging |
| 50 | dry food product | 52 | top loop |
| 54 | trench | 56 | gasket |

### DETAILED DESCRIPTION OF THE INVENTION

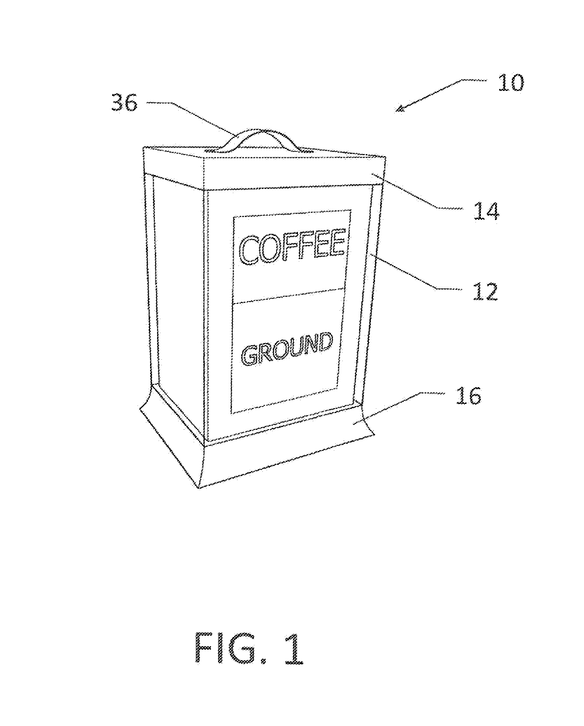

FIG. 1 illustrates the preferred embodiment of the present invention. The dry food packaging container 10 for display and storage is generally comprised of body 12 (having a double-wall), lid 14, and base 16. An optional container handle 36 is shown attached to lid 14.

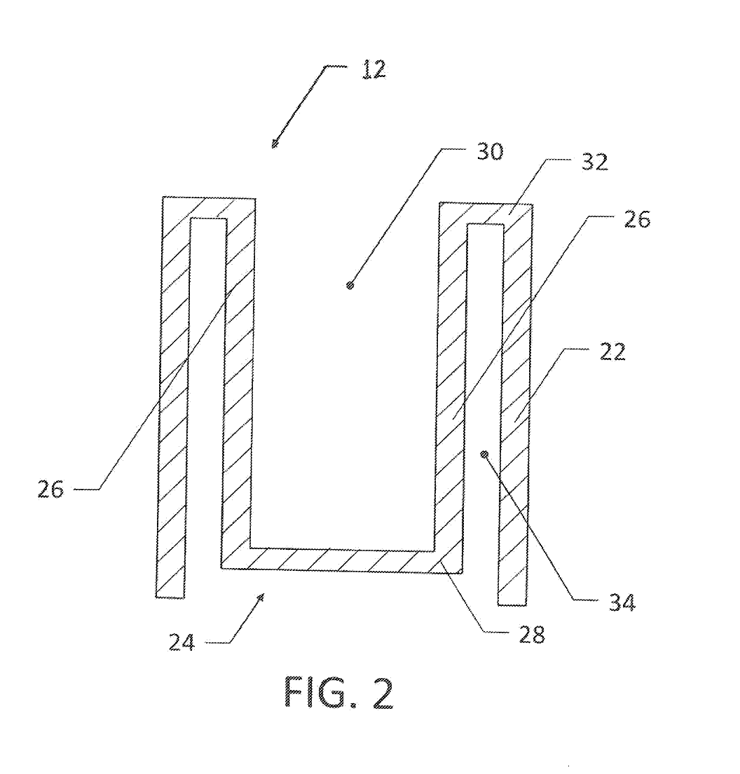

As shown FIG. 2, body 12 further comprises outer wall 22, inner wall 26, food storage member 24, seam 32, and storage compartment 34. In the preferred embodiment, it is necessary for outer wall to be translucent. Outer wall 22 preferably is made of clear polycarbonate plastic. However, outer wall 22 can be made of any sturdy translucent material, such as acrylic plastic or glass.

Food storage member 24, also shown in FIG. 2, further comprises storage cavity 30, food storage member base 28, and inner wall 26. Inner wall 26 and inner base 28 is one integrated unit and open at the top to form storage cavity 30. Food storage member 24 is preferably made of any non-porous material capable of preventing its contents from being exposed to air, such as non-porous plastic, glass, metal or ceramic. Additionally, in the preferred embodiment, food storage member 24 is approximately 3.5 inches wide by 2.25 inches deep, and 8.0 inches in height, but can be larger or smaller as needed, and should not be limited by these dimensions.

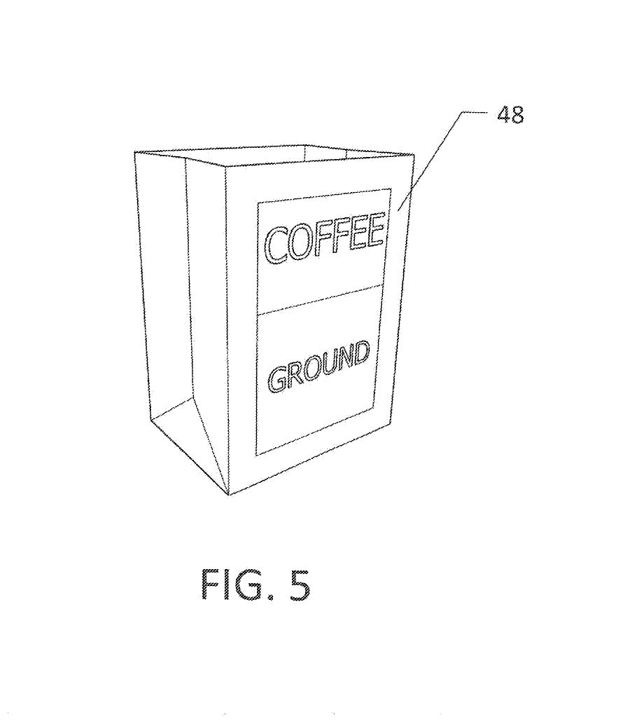

Both food storage member 24 and outer wall 22 are preferably of the same basic shape and height, with outer wall 22 being slightly longer and wider than food storage member 24. In the preferred embodiment, both food storage member 24 and outer wall 22 are box-shaped and are approximately 8.0 inches high, but can be proportionately larger or smaller and can be rectangular, square or cylindrical. Further, food storage member base 28 and inner wall 26 can be curved such that there is no right angled bend within food storage member 24. Seam 32 joins together inner wall 26 and outer wall 22. Storage compartment 34 is comprised of the space between inner wall 26, outer wall 22 and seam 32. In the preferred embodiment, the distance between inner wall 26 and outer wall 22 is generally between 0.25 and 0.75 inches, but can be larger or smaller. The empty product packaging 48, which is known and an example of which is shown in FIG. 5, can be inserted into storage compartment 34 and is visible through the translucent outer walls 22. A generic food product packaging can be provided for users which desire a particular product that is not packaged in typical packaging. For example, a user who purchases whole bean coffee can use a re-usable package that identifies the product as whole bean coffee.

In the preferred embodiment shown in FIG. 1, handle 36 is in the form of a pull handle, which is known. However, handle 36 can be made up of any device capable of facilitating easier opening and closing of lid 14, such as a knob, drop handle, or pendant pull. Handle 36 is permanently affixed to lid 14, by either epoxy, screws, glue or any other method of attaching the material chosen to make up handle 36 to the material chosen to make up lid 14.

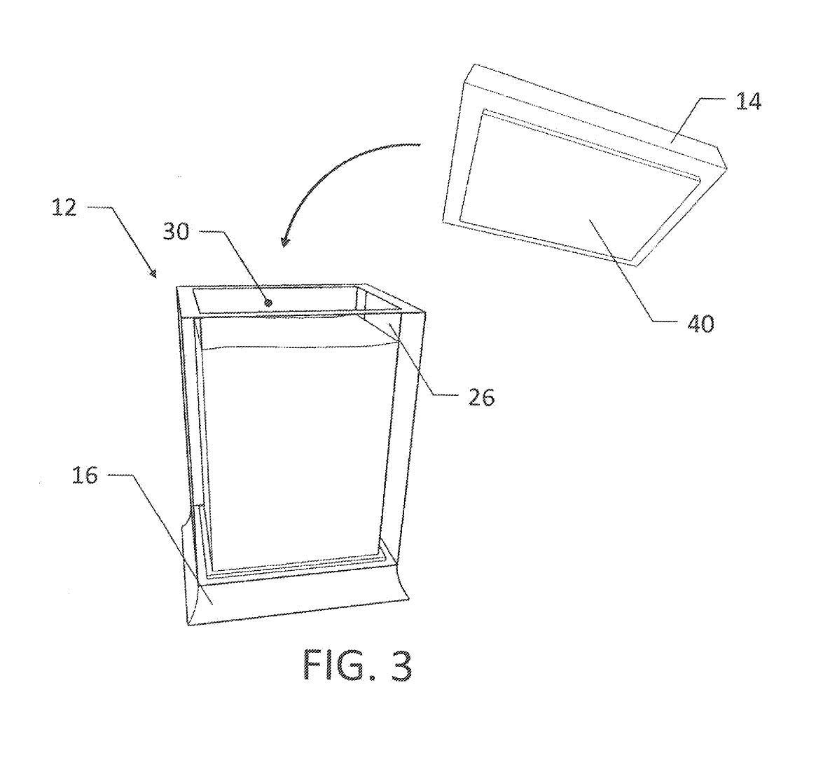

Returning to FIG. 3, lid 14 includes a container seal 40 which fits over storage cavity 30. A hermetic seal is created between inner wall 26 and container seal 40. In the preferred embodiment, container seal 40 is made of rubber and is in the form of a rubber stopper, which is known. However, container seal 40 can also be made of flexible plastic or silicone. Additionally, container seal 40 can be formed of any other type of known method of creating a seal. For example, a retractable pressure seal may be used, wherein container seal 40 could be connected to handle 36 by a known method.

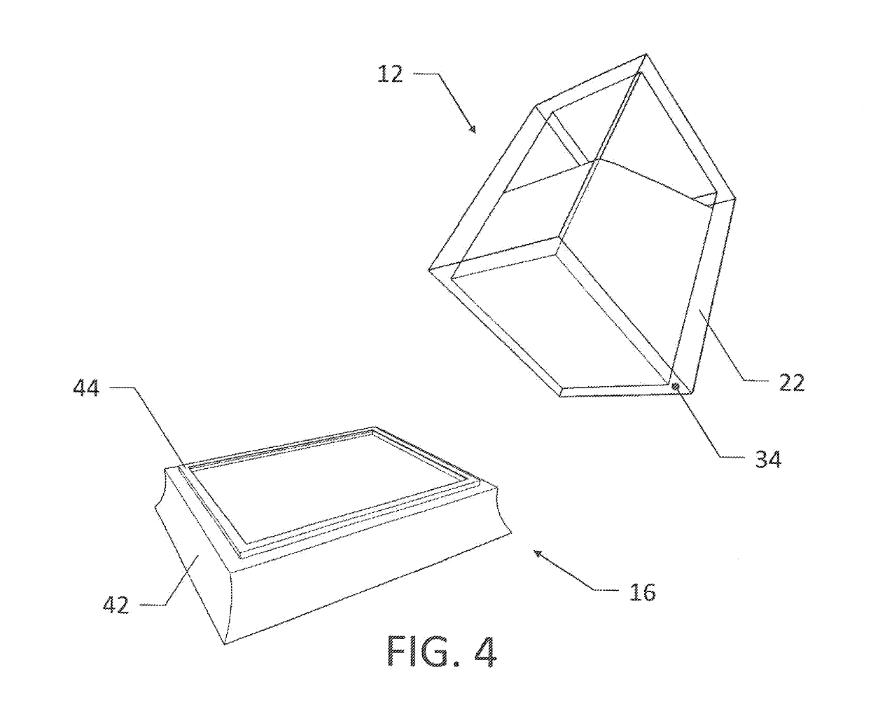

As shown in FIG. 4, base 16 is preferably comprised of stand 42 and base seal 44. Stand 42 is a platform which holds body 12 when in the fully assembled position. Stand 42 can be in any shape or form, as long as it is capable of supporting a body 12 and enclosing food storage compartment 34 such that packaging (shown in FIGS. 5, 7 and 8) can be securely displayed within body 12. An optional base seal 44 is shown which outer wall 22 can fit around it's perimeter to better seal storage compartment 34.

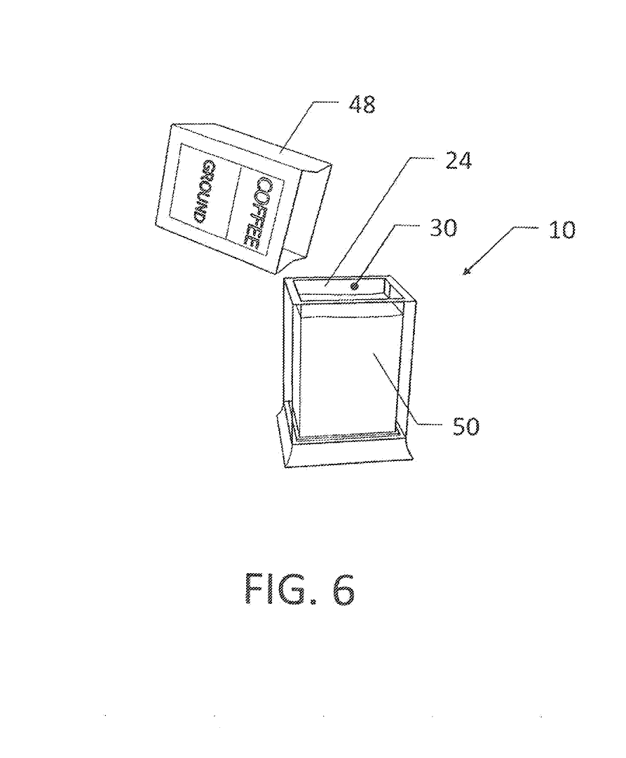

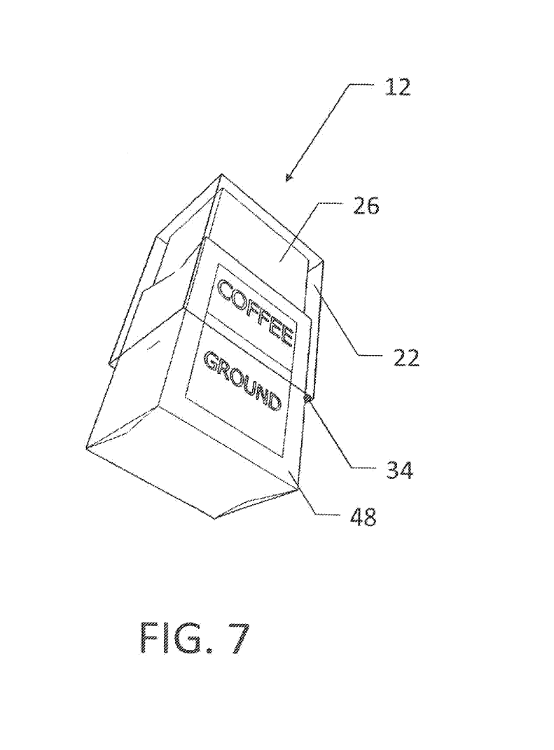

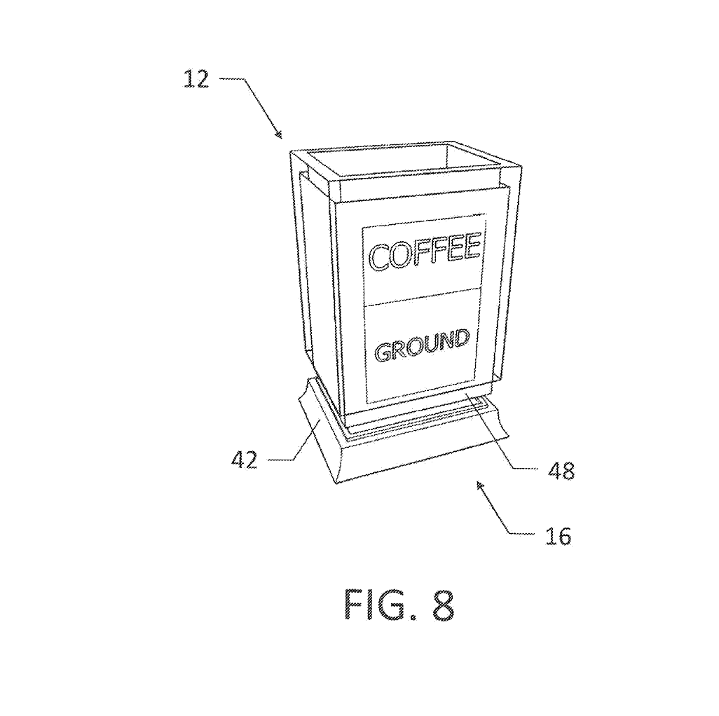

FIG. 5 shows an example of the type of pre-packaged dry food product, which is known, that can be stored in the present invention. The known dry food product (not shown) will be stored inside of the present invention and product packaging 48 will be inserted into the present invention to become a label for the contents stored therein, as illustrated in FIG. 6, FIG. 7 and FIG. 8.

FIG. 6 illustrates the present invention being used to store and display pre-packaged dry food product. As can be seen in this illustration, dry food product 50 is emptied from product packaging 48 into food storage member 24 via food storage cavity 30. Once dry food product 50 is completely emptied into food storage compartment 24, FIG. 7 illustrates empty product packaging 48 being inserted into storage compartment 34 of body 12 between outer wall 22 and inner wall 26. As outer wall 22 is made of a translucent material, product packaging 48 can be seen through outer wall 22 so that a user can identify the specific dry food product 50 (not visible) contained within the present invention. As shown in FIG. 8, once the dry food product 50 (not visible) and product packing 48 are properly loaded, body 12 is positioned onto stand 42 and product packing 48 is held in place.

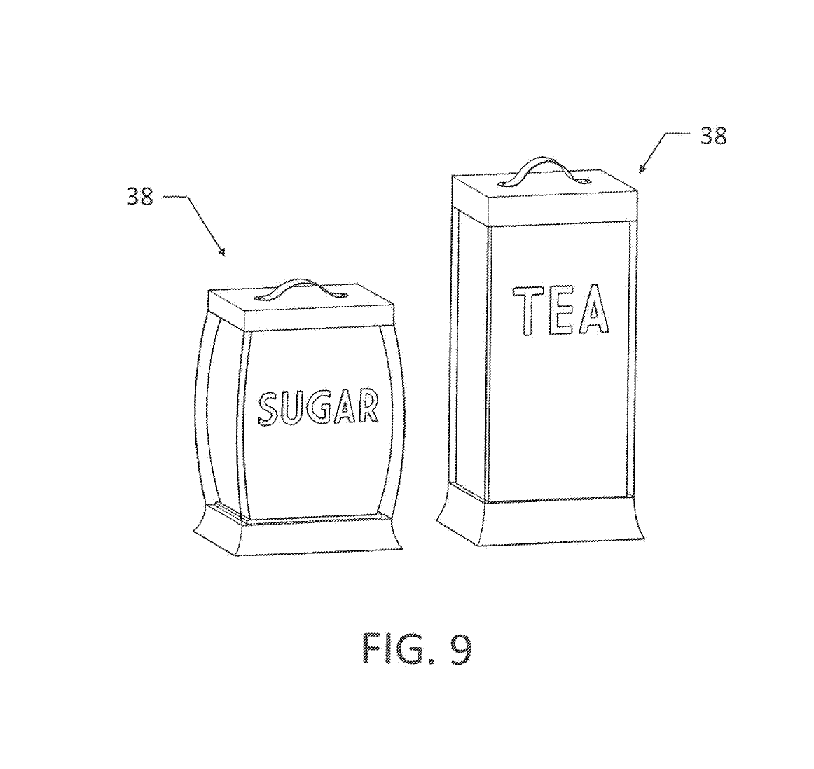

In an alternate embodiment of the present invention, FIG. 9 illustrates fully assembled containers 38, shown with varying dimensions which allow for different sizes and types of dry food product packaging as well as different quantities of dry food products. Moreover, modifications for the distance between inner wall 26 and outer wall 22 and the width of seam 32 can be increased or decreased in order to accommodate thicker or thinner food product packaging 48.

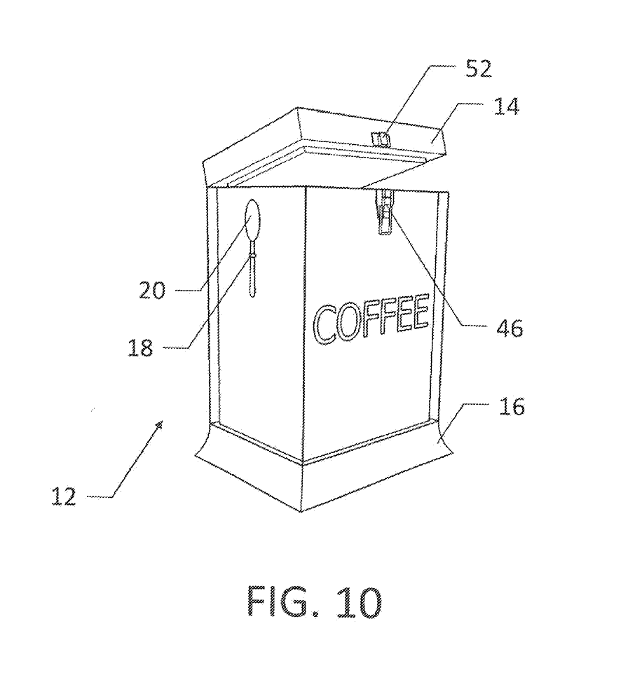

FIG. 10 illustrates other alternate embodiments of the present invention, which provide for the attachment of scoop 20 and an alternate sealing method. In FIG. 10, scoop holder 18, in which a detachable scoop 20 can be placed, can be affixed to the exterior of body 12. Additionally, lid 14 can be attached to body 12 by way of a hinge or other mechanism. Lid 14 could also be sealed by a latch 46 which connects to a top loop (or hasp) 52 and is latched down to seal by a bail closure type of arrangement. Similarly, body 12 can be secured to base 16 in the same method if desired.

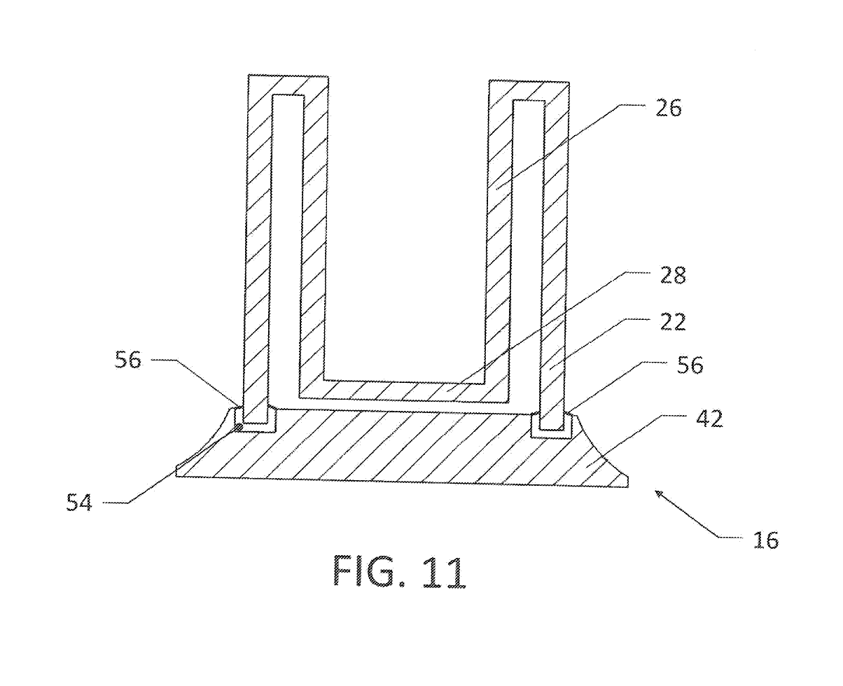

Furthermore, as shown in a cross-section view in FIG. 11, base 16 could include a trench 54 depressed down into the top of stand 42. Trench 54 is positioned around the perimeter of base 16 such that outer wall 22 fits into trench 54 and is held in place by gasket 56. Inner wall 26 and food storage member base 28 do not extend as far down as outer wall 22, so packaging (not shown) can fit in space between food storage member base 28 and stand 42.

Having described my invention, I claim:

1. A container for storing dry food, said container comprising:
a. a body having:
i. an inner wall;
ii. an outer wall;
iii. a storage member base; and
iv. a seam connecting said inner wall to said outer wall;
b. wherein said inner wall and said storage member base of said body are configured to form a storage cavity;
c. wherein said inner wall, said seam and said outer wall of said body are configured to form a storage compartment;
d. a base, wherein said base removably attaches to said body, enclosing said storage compartment; and
e. a lid, wherein said lid removably attaches to said body, enclosing said storage cavity.

2. A container as recited in claim 1, wherein said storage compartment is configured to accept a coffee product package.

3. A container as recited in claim 1, wherein said outer wall is translucent.

4. A container as recited in claim 2, wherein when said coffee product package is placed within said storage compartment, said coffee product package is visible through said outer wall of said body.

5. A container as recited in claim 1, wherein said lid further comprises a container seal which hermetically seals said storage cavity.

6. A container as recited in claim 1, wherein said lid further comprises a handle.

7. A container as recited in claim 1, wherein said inner wall, said seam, said outer wall and said member base form an integrated storage member.

8. A container as recited in claim 1, wherein said base further comprises a stand and a base seal, wherein said base seal acts to seal said storage compartment.

9. A container as recited in claim 1, further comprising a scoop holder affixed to said body of said container.

10. A container as recited in claim 1, further comprising a latch and a top loop, configured to secure said lid to said body.

11. A container for storing dry food and displaying a product packaging, said container comprising:
a. a body having:
i. an inner wall;
ii. an outer wall;
iii. a storage member base; and
iv. a seam connecting said inner wall to said outer wall;
b. wherein said body forms a storage cavity within said inner wall configured to accept said dry food, and a storage compartment between said inner wall and said outer wall configured to accept said product packaging;
c. a base having a stand and a seal, wherein said base can removably attach to said body such that said base encloses said storage compartment; and
d. a lid removably attached to said body.

12. A container as recited in claim 11, wherein said storage, compartment is configured to accept a coffee product package.

13. A container as recited in claim 11, wherein said outer wall is translucent.

14. A container as recited in claim 12, wherein when said coffee product package is placed within said storage compartment, said coffee product package is visible through said outer wall of said body.

15. A container as recited in claim 11, wherein said lid further comprises a container seal which hermetically seals said storage cavity.

16. A container as recited in claim 11, wherein said lid further comprises a handle.

17. A container as recited in claim 11, wherein said inner wall, said seam, said outer wall and said compartment base form an integrated storage member.

18. A container as recited in claim 11, further comprising a scoop holder affixed to said body of said container.

19. A container as recited in claim 11, further comprising a latch and a top loop, configured to secure said lid to said body.
